(19) United States
(12) Patent Application Publication
(10) Pub. No.: US 2026/0358561 A1
(43) Pub. Date: Nov. 12, 2026

(54) FUSION SPLICER

(71) Applicant: Fujikura Ltd., Tokyo (JP)

(72) Inventor: Hiroyuki Oka, Sakura-shi (JP)

(73) Assignee: Fujikura Ltd., Tokyo (JP)

(21) Appl. No.: 19/470,319

(22) PCT Filed: Apr. 5, 2024
(86) PCT No.: PCT/JP2024/014187

§ 371 Date: Sep. 29, 2025

(30) Foreign Application Priority Data
Apr. 7, 2023 (JP) 2023-062777

(51) Int. Cl. G02B 6/255

(52) U.S. Cl. CPC G02B 6/2553

(57) ABSTRACT

A fusion splicer includes: a device main body including a heating unit that heats an optical fiber; a pedestal member including a coating holding part that holds a coating portion of the optical fiber; a clamp member including a coating clamp that clamps the coating portion between the coating holding part and the coating clamp, and rotating around a clamp rotation shaft fixed to the pedestal member; and an operation member rotating around a first rotation shaft fixed to the pedestal member, wherein the clamp member rotates in a direction toward the pedestal member in interlocking with the rotation of the operation member.

### TECHNICAL FIELD

The present invention relates to a fusion splicer.

Priority is claimed on Japanese Patent Application No. 2023-062777, filed Apr. 7, 2023, the content of which is incorporated herein by reference.

### BACKGROUND

Patent Literature 1 discloses a fusion splicer for heating and fusion-splicing optical fibers together. The fusion splicer includes a heating unit that heats a pair of optical fibers, and a coating clamp for holding a coating portion of each optical fiber. Fusion-splicing is performed by clamping the optical fiber with the coating clamp or the like and heating glass portions of the pair of optical fibers with the heating unit.

### PATENT LITERATURE

[PTL 1]

Japanese Unexamined Patent Application, First Publication No. 2014-38361

To perform the fusion-splicing properly, it is preferable to close the coating clamp in a state where the optical fiber is in a predetermined position. Here, the optical fiber may float or move from the predetermined position due to its rigidity until it is clamped by the coating clamp. For this reason, in the fusion splicer of the related art, when an optical fiber is clamped by a coating clamp, the user holds the optical fiber with one hand and operates the coating clamp with the other hand. In other words, both hands are used to hold one optical fiber by the coating clamp. Therefore, fusion-splicing work is complicated and time consuming.

### SUMMARY

One or more embodiments of the present invention provide a fusion splicer that can improve the efficiency of fusion-splicing work without complicated work.

A fusion splicer according to aspect 1 of the present invention includes: a device main body including a heating unit that heats a pair of optical fibers arranged in a left-right direction; a pedestal member including a coating holding part that holds a coating portion of one of the pair of optical fibers; a clamp member including a coating clamp that clamps the coating portion between the coating holding part and the coating clamp, and rotating around a clamp rotation shaft fixed to the pedestal member; and an operation member rotating around a first rotation shaft fixed to the pedestal member, wherein the clamp member rotates in a direction toward the pedestal member in interlocking with the rotation of the operation member.

According to aspect 1, the coating clamp is closed in interlocking with the operation member, and thus the work of clamping the optical fiber by the coating clamp becomes easy. Therefore, it is possible to improve the efficiency of the fusion-splicing work of the optical fibers.

As aspect 2 of the present invention, in the fusion splicer according to aspect 1, the coating clamp is closed in interlocking with a downward rotating operation of the operation member.

According to aspect 2, while the user holds the optical fiber with his or her fingers and moves the optical fibers toward the coating holding part, the user can easily operate the operation part with those fingers. In other words, it is possible to close the coating clamp with one hand while easily holding the optical fiber. Therefore, it is possible to further improve the efficiency of the fusion-splicing work.

As aspect 3 of the present invention, the fusion splicer according to aspect 1 or 2 further includes a conversion part that converts an operation of the operation member around the first rotation shaft into an operation of the clamp member around the clamp rotation shaft.

According to aspect 3, it is possible to realize a structure in which the coating clamp is closed in interlocking with the operation of the operation part. Further, by changing the shape or the like (for example, the leverage ratio) of the conversion part, it is possible to easily change the operating force of the operation part.

As aspect 4 of the present invention, in the fusion splicer according to aspect 3, an interlocking unit including the operation member, the clamp member, and the conversion part is detachable from the device main body.

According to aspect 4, it is possible to replace the interlocking unit depending on the type of the optical fibers to be fusion-spliced.

As aspect 5 of the present invention, in the fusion splicer according to aspect 3 or 4, the pedestal member further includes a second rotation shaft fixed to the pedestal member, the operation member includes one of an operation part and an outer guide part, and the intermediate part, the conversion part includes a first arm and a second arm, and when the one of the operation part and the outer guide part is pressed down, the operation member rotates, the intermediate part pushes down the first arm, the conversion part rotates around the second rotation shaft, and the second arm pushes up the clamp member, so that a moment around the clamp rotation shaft acts on the clamp member in a direction of closing the clamp member, and the clamp member rotates in the direction toward the pedestal member.

As aspect 6 of the present invention, the fusion splicer according to any one of aspects 1 to 5 further includes a biasing member that biases the coating clamp in an opening direction.

According to aspect 6, until a force for closing the coating clamp (for example, a magnetic force or the like) exceeds the biasing force, when the operation of the operation part is stopped, the coating clamp is opened by the biasing force. In other words, the amount of rotation of the coating clamp can be made to follow the amount of rotation of the operation part. Therefore, operability can be further improved.

According to the above aspect of the present invention, it is possible to improve the efficiency of fusion-splicing work.

### BRIEF DESCRIPTION OF THE DRAWINGS

FIG. 1 is a perspective view of a fusion splicer according to one or more embodiments.

FIG. 2 is a perspective view of a windshield cover of FIG. 1 in an open state.

FIG. 3 is a simplified diagram of a splicing structure of one or more embodiments.

FIG. 4A is a perspective view of an interlocking unit of one or more embodiments, showing a state in which the coating clamp is opened.

FIG. 4B is a perspective view showing a state in which the coating clamp of the interlocking unit of FIG. 4A is closed.

FIG. 5A is an exploded perspective view of the interlocking unit of FIG. 4A.

FIG. 5B is a rear view of the exploded perspective view of FIG. 5A.

FIG. 6A is a diagram illustrating an operation of the interlocking unit of FIG. 4A.

FIG. 6B is a diagram illustrating an operation following FIG. 6A.

### DETAILED DESCRIPTION

Hereinafter, a fusion splicer of one or more embodiments is explained on the basis of the drawings.

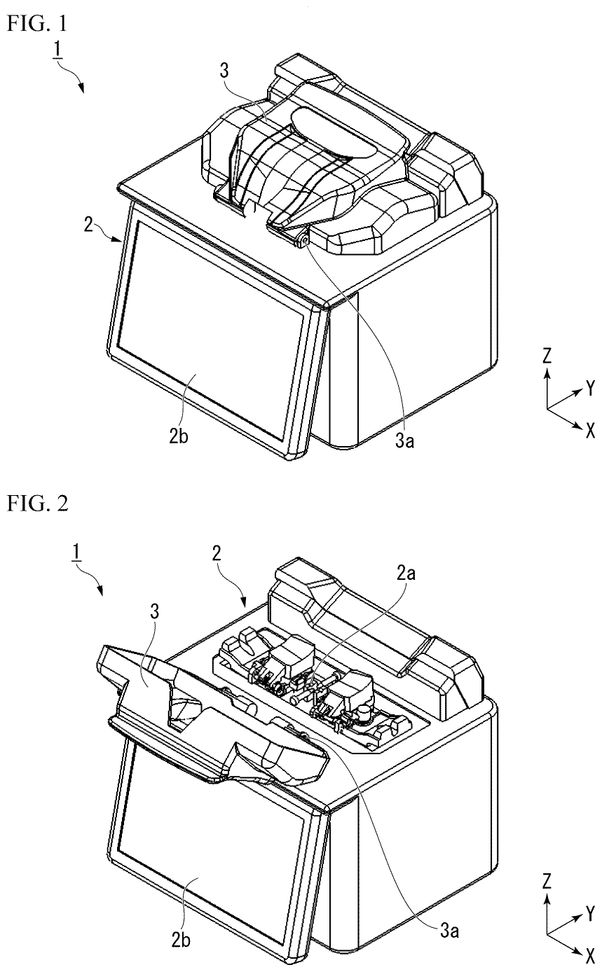

As shown in FIGS. 1 to 3, the fusion splicer 1 is configured to fusion-splice a pair of optical fibers F1 and F2. Each of the optical fibers F1 and F2 includes a glass portion G and a coating portion C that coats the glass portion G. The coating portion C may consist of a single layer or may consist of a plurality of layers. The coating portion C in one or more embodiments includes a first coating layer C1 and a second coating layer C2 that coats the first coating layer C1 from the outside. The first coating layer C1 and the second coating layer C2 are made of a resin. The coating portion C may include three or more coating layers.

The fusion splicer 1 may be configured to collectively fusion-splice a first optical fiber unit including the optical fiber F1 and a second optical fiber unit including the optical fiber F2. In other words, the fusion splicer 1 may fusion-splice single-core optical fibers F1 and F2 together, or may collectively fusion-splice multiple-core optical fiber units together. That is, “fusion-splicing a pair of optical fibers” includes fusion-splicing multiple-core optical fiber units together.

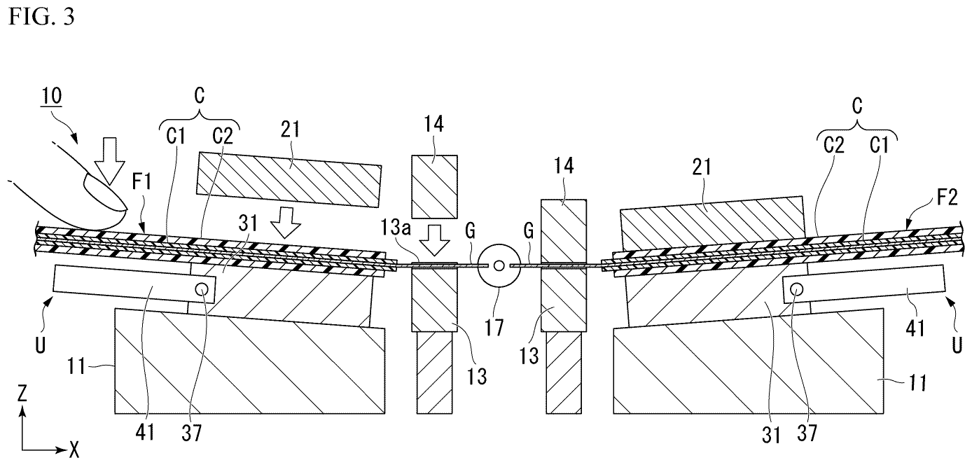

As shown in FIG. 1, the fusion splicer 1 includes a device main body 2 that is box-shaped in appearance. A windshield cover 3 is provided on the upper portion of the device main body 2. The windshield cover 3 is rotatable around a rotation center 3a. As shown in FIG. 2, when the windshield cover 3 rotates around the rotation center 3a, the splicing structure 10 for fusion-splicing the optical fibers F1 and F2 is exposed. The splicing structure 10 includes a heating unit (i.e., heater) 2a that heats the optical fibers F1 and F2. Further, the device main body 2 includes a display unit 2b that displays an image captured by a camera built in the device main body 2 or the like.

Hereinafter, the splicing structure 10 of one or more embodiments is explained using FIG. 3. In FIG. 3, each member is shown in a simplified manner to facilitate understanding of the structure.

As shown in FIG. 3, the splicing structure 10 includes a pair of movable stages 11, a pair of coating holding parts (i.e., coating holders) 31, a pair of glass holding parts 13, a pair of glass clamps 14, and a pair of coating clamps 21. Further, the splicing structure 10 includes a pair of electrode rods 17 (only one electrode rod 17 is shown in FIG. 3). A direction in which the optical fibers F1 and F2 are arranged (a direction in which the optical fibers F1 and F2 face each other) and a direction in which the pair of electrode rods 17 face each other are orthogonal to each other.

### Direction Definitions

In one or more embodiments, the direction in which the optical fibers F1 and F2 are arranged is referred to as a left-right direction X, and is represented by an X axis. Further, the direction in which the pair of electrode rods 17 face each other is referred to as a front-rear direction Y, and is represented by a Y axis. A vertical direction Z orthogonal to both the left-right direction X and the front-rear direction Y is represented by a Z axis. The left-right direction X is also a direction in which the pair of optical fibers F1 and F2 extend. In the left-right direction X, a side toward the pair of electrode rods 17 is referred to as an inner side, and a side away from the pair of electrode rods 17 is referred to as an outer side.

The splicing structure 10 has a substantially symmetrical structure in the left-right direction X with the pair of electrode rods 17 as the center.

Although not shown in the drawings, the pair of electrode rods 17 are disposed with spacing therebetween in the front-rear direction Y. Each electrode rod 17 has a tapered shape whose outer diameter decreases toward the inner side (the side toward the optical fibers F1 and F2) in the front-rear direction Y. By arranging the abutting surfaces of the optical fibers F1 and F2 between the electrode rods 17 and discharging electricity toward the abutting surfaces, the tip ends of the optical fibers F1 and F2 can be heated and fusion-spliced. In other words, the heating unit 2a of one or more embodiments is constituted by the pair of electrode rods 17. Instead of the electrode rods 17, a heater or the like may be used as the heating unit 2a.

The pair of movable stages 11 are disposed with spacing therebetween in the left-right direction X and are attached to the device main body 2. The pair of movable stages 11 are each movable in the left-right direction X with respect to the device main body 2. As shown in FIG. 3, when viewed in the front-rear direction Y, the pair of movable stages 11 are disposed such that the electrode rods 17 are sandwiched therebetween. That is, each movable stage 11 can move forward and backward with respect to the electrode rods 17. A power source (not shown in the drawings) (such as a motor) for driving the movable stage 11 is provided within the device main body 2.

The pair of coating holding parts 31 are respectively located above the movable stages 11. The pair of coating clamps 21 are respectively located above the coating holding parts 31. The coating holding parts 31 and the coating clamps 21 are attached to the movable stages 11. For this reason, when the movable stages 11 move in the left-right direction X, the coating holding parts 31 and the coating clamps 21 also move in the left-right direction X.

The glass clamps 14 are located above the glass holding parts 13. The glass clamps 14 may be configured to be manually closed and opened by a user. Alternatively, the glass clamps 14 may be configured to be opened and closed in interlocking with the opening and closing operations of the windshield cover 3.

As shown in FIG. 3, the glass holding parts 13 are located between the electrode rods 17 and the coating holding parts 31 when viewed in the front-rear direction Y. V-shaped grooves 13a that open upward are formed in the upper surfaces of the glass holding parts 13. The grooves 13a extend in the left-right direction X. The relative positions of the glass portions G of the optical fibers F1 and F2 are determined by respectively placing the glass portions G in the grooves 13a of the pair of glass holding parts 13. The shape of the grooves 13a is not limited to a V shape, and may be any shape as long as the positions of the glass portions G can be determined. For example, the grooves 13a may have a U shape or may have a trapezoidal shape. The material of the glass holding parts 13 is a material that can withstand electric discharge heating, such as a ceramic.

The coating clamps 21 are rotatably provided with respect to the coating holding parts 31. The coating clamps 21 can open and close the upper surfaces of the coating holding parts 31. The coating clamps 21 can clamp the coating portions C of the optical fibers F1 and F2 between the coating clamps 21 and the coating holding parts 31. Further, the coating clamps 21 can be switched between a state in which the optical fibers F1 and F2 are clamped and a state in which the optical fibers F1 and F2 are not clamped, by opening and closing the upper surface of the coating holding parts 31. Portions of the coating clamps 21 that come into contact with the coating portion C are made of an elastic material (for example, rubber).

Here, the fusion splicer 1 of one or more embodiments includes a pair of operation parts 41 for closing the pair of coating clamps 21. As shown in FIG. 3, when the user presses down one operation part 41 of the operation parts 41 with his or her finger, the coating clamp 21 corresponding to the one operation part 41 is closed. Further, the operation parts 41 are respectively disposed near the coating holding parts 31 on which the optical fibers F1 and F2 are placed. Therefore, the user can place the optical fiber F1 or the optical fiber F2 on the coating holding part 31 and at the same time close the coating clamp 21. In other words, the operation of placing the optical fiber F1 or the optical fiber F2 and the operation of closing the coating clamp 21 to clamp the optical fiber F1 or the optical fiber F2 can be performed with one hand.

In one or more embodiments, a structure for interlocking the coating clamp 21 with the operation part 41 is referred to as an “interlocking unit U”. As shown in FIG. 3, the fusion splicer 1 includes a pair of interlocking units U. The pair of interlocking units U are disposed such that the electrode rods 17 are sandwiched therebetween in the left-right direction X. The pair of interlocking units U have a substantially symmetrical structure in the left-right direction. For this reason, in the following description, the left-hand interlocking unit U in FIG. 3 is described as a representative of the pair of interlocking units U.

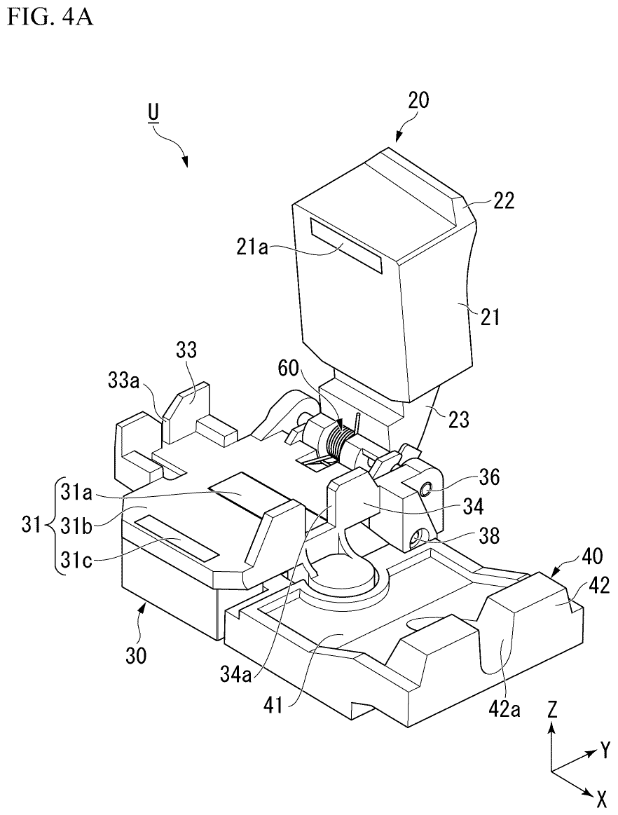

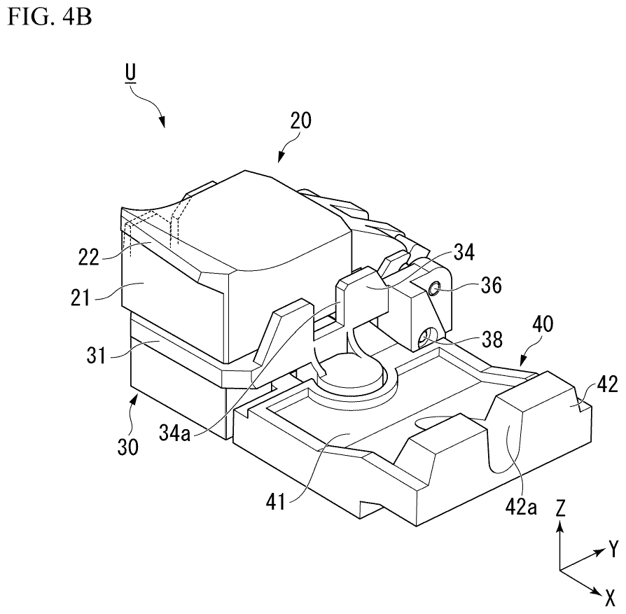

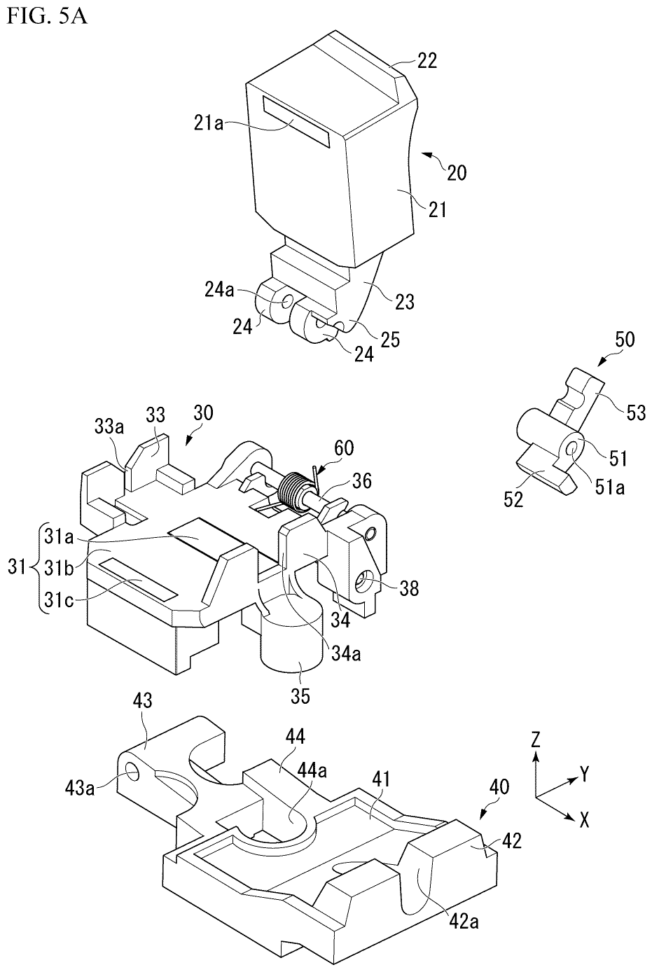

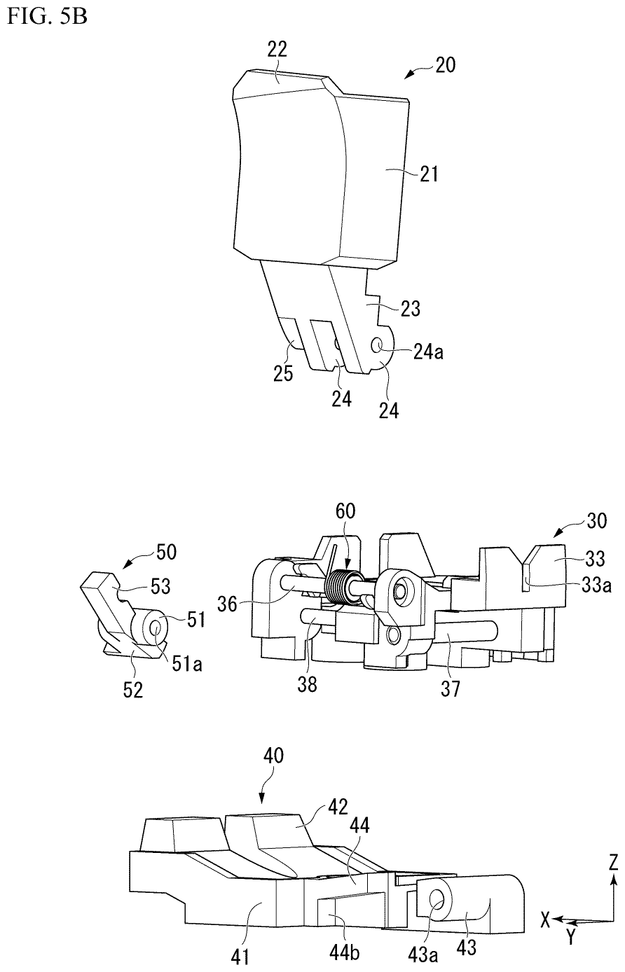

FIG. 4A is a perspective view of the interlocking unit U in a state in which the coating clamp 21 is opened. FIG. 4B is a perspective view of the interlocking unit U in a state in which the coating clamp 21 is closed. As shown in FIGS. 4A and 4B, the interlocking unit U includes a clamp member 20 having the coating clamp 21, a pedestal member (i.e., pedestal) 30 having the coating holding part 31, an operation member 40 having the operation part 41, and a biasing member 60. FIG. 5A is an exploded perspective view of the interlocking unit U of FIG. 4A. FIG. 5B is a rear view of FIG. 5A. As shown in FIGS. 5A and 5B, the interlocking unit U further includes a conversion part (i.e., converter) 50.

As shown in FIG. 5A, the clamp member 20 includes an operation protrusion 22, a connecting part 23, a pair of clamp bearing parts 24, and a contact part 25 in addition to the coating clamp 21. The operation protrusion 22 protrudes from the coating clamp 21. The operation protrusion 22 is a portion operated by the user when the coating clamp 21 in the closed state is opened. The pair of clamp bearing parts 24 are disposed with spacing therebetween in the left-right direction X. A shaft hole 24a is formed in each of the pair of clamp bearing parts 24. A clamp rotation shaft 36 fixed to the pedestal member 30 is inserted into the shaft holes 24a. As a result, the clamp member 20 is rotatable around the clamp rotation shaft 36.

The connecting part 23 connects the pair of clamp bearing parts 24 and the coating clamp 21 to each other. The contact part 25 is disposed side by side with the pair of clamp bearing parts 24 in the left-right direction X. The contact part 25 is a portion with which the conversion part 50 comes into contact when the clamp member 20 is interlocked with the operation of the operation part 41.

As shown in FIG. 5A, the pedestal member 30 includes a first guide part 33, a second guide part 34, and a guide pin 35 in addition to the coating holding part 31. Further, as shown in FIG. 5B, the clamp rotation shaft 36, a first rotation shaft 37, and a second rotation shaft 38 are fixed to the pedestal member 30.

The clamp rotation shaft 36 and the first rotation shaft 37 are provided such that the extending direction of the clamp rotation shaft 36 and the extending direction of the first rotation shaft 37 are different from each other. For example, the clamp rotation shaft 36 and the first rotation shaft 37 may be provided such that the extending direction of the clamp rotation shaft 36 and the extending direction of the first rotation shaft 37 are orthogonal to each other.

The clamp rotation shaft 36 and the second rotation shaft 38 are provided such that the extending direction of the clamp rotation shaft 36 and the extending direction of the second rotation shaft 38 are same as each other. For example, the clamp rotation shaft 36 and the second rotation shaft 38 may be provided such that the extending direction of the clamp rotation shaft 36 and the extending direction of the second rotation shaft 38 are parallel to each other.

As shown in FIG. 5A, the coating holding part 31 includes an elastic member 31a, a base 31b, and a magnetic member 31c. The elastic member 31a and the magnetic member 31c are fitted into the two depressions of the base 31b, respectively. The magnetic member 31c may be a magnet, or may be a metal member that is attracted to the magnet. The coating clamp 21 is provided with a clamp-side magnetic member 21a that generates a magnetic force (an attractive force) between the clamp-side magnetic member 21a and the magnetic member 31c. For this reason, when the clamp member 20 rotates and the spacing between the clamp-side magnetic member 21a and the magnetic member 31c becomes smaller, a magnetic force acts in a direction of closing the coating clamp 21. As a result, the coating clamp 21 is maintained in a closed state.

The first guide part 33 is located more inside in the left-right direction X than the second guide part 34. In other words, the first guide part 33 is disposed closer to the electrode rod 17 than the second guide part 34. A first guide groove 33a is formed in the first guide part 33. The glass portion G is disposed inside the first guide groove 33a. As a result, the position of the glass portion G is determined in the vicinity of the electrode rods 17. The second guide part 34 is located more outside in the left-right direction X than the first guide part 33. The second guide part 34 includes a second guide groove 34a. The coating portion C is disposed inside the second guide groove 34a.

The clamp rotation shaft 36 extends in the left-right direction X. The clamp rotation shaft 36 is a portion that becomes the center of rotation of the clamp member 20. Both end portions of the clamp rotation shaft 36 are supported by the pedestal member 30. The biasing member 60 is a coil spring, and the clamp rotation shaft 36 is inserted inside the coil portion of the biasing member 60. In other words, the biasing member 60 is attached to the clamp rotation shaft 36. That is, the part where the biasing member 60 is provided is only the clamp rotation shaft 36. The biasing member 60 biases the clamp member 20 in a direction in which the coating clamp 21 opens.

As shown in FIG. 5B, the first rotation shaft 37 extends in the front-rear direction Y. The first rotation shaft 37 is a portion that becomes the center of rotation of the operation member 40. Both end portions of the first rotation shaft 37 are supported by the pedestal member 30. The second rotation shaft 38 extends in the left-right direction X. The second rotation shaft 38 is a portion that becomes the center of rotation of the conversion part 50. Both end portions of the second rotation shaft 38 are supported by the pedestal member 30.

As shown in FIG. 5A, the operation member 40 includes an outer guide part 42, a first bearing part 43, and an intermediate part 44 in addition to the operation part 41. The operation part 41 has a plate shape extending in the front-rear direction Y and the left-right direction X. The operation part 41 is located more outside in the left-right direction X than the coating holding part 31 and the second guide part 34 of the pedestal member 30. The outer guide part 42 protrudes upward from the operation part 41. The outer guide part 42 is located more outside in the left-right direction X than the second guide part 34. An outer guide groove 42a is formed in the outer guide part 42. The coating portion C of each of the optical fibers F1 and F2 is accommodated inside the outer guide groove 42a.

The first bearing part 43 includes a first shaft hole 43a extending in the front-rear direction Y. The first rotation shaft 37 is inserted inside the first shaft hole 43a. As a result, the operation member 40 rotates around the first rotation shaft 37. The intermediate part 44 is located between the first bearing part 43 and the operation part 41. A guide hole 44a is formed in the intermediate part 44. When the interlocking unit U is assembled, the guide pin 35 of the pedestal member 30 is inserted inside the guide hole 44a. As a result, it is easy to align and assemble the operation member 40 to the pedestal member 30. A gap is provided between the guide pin 35 and the guide hole 44a not to impede the rotation of the operation member 40 around the first rotation shaft 37. As shown in FIG. 5B, an accommodating portion 44b is formed in the lower surface of the intermediate part 44. The accommodating portion 44b is a recess that is depressed upward.

As shown in FIG. 5A, the conversion part 50 includes a second bearing part 51, a first arm 52, and a second arm 53. The second bearing part 51 includes a second shaft hole 51a extending in the left-right direction X. The second rotation shaft 38 is inserted inside the second shaft hole 51a. As a result, the conversion part 50 rotates around the second rotation shaft 38. The first arm 52 and the second arm 53 extend from the second bearing part 51 in the radial direction of the second shaft hole 51a.

The first arm 52 is disposed in the accommodating portion 44b of the operation member 40. When the operation part 41 is pressed down and the operation member 40 rotates around the first rotation shaft 37, the intermediate part 44 pushes down the first arm 52. In other words, the first arm 52 is a portion that comes into contact with the intermediate part 44 from below. The second arm 53 is a portion that presses the contact part 25 of the clamp member 20.

Next, the operation of the fusion splicer 1 configured as above is explained.

Before performing fusion-splicing work, the interlocking unit U is in the state shown in FIG. 4A. That is, the clamp member 20 is in an opened state. The coating clamp 21 is biased in the opening direction by the biasing member 60, and the clamp-side magnetic member 21a is sufficiently separated from the magnetic member 31c, and thus the clamp member 20 is maintained in the opened state. When performing the fusion splice, the user grips the coating portion C of the optical fiber F1 or the optical fiber F2 with his or her finger and places the coating portion C on the pedestal member 30. At this time, the coating portion C is placed inside the second guide groove 34a and the outer guide groove 42a, and the glass portion G is placed inside the first guide groove 33a.

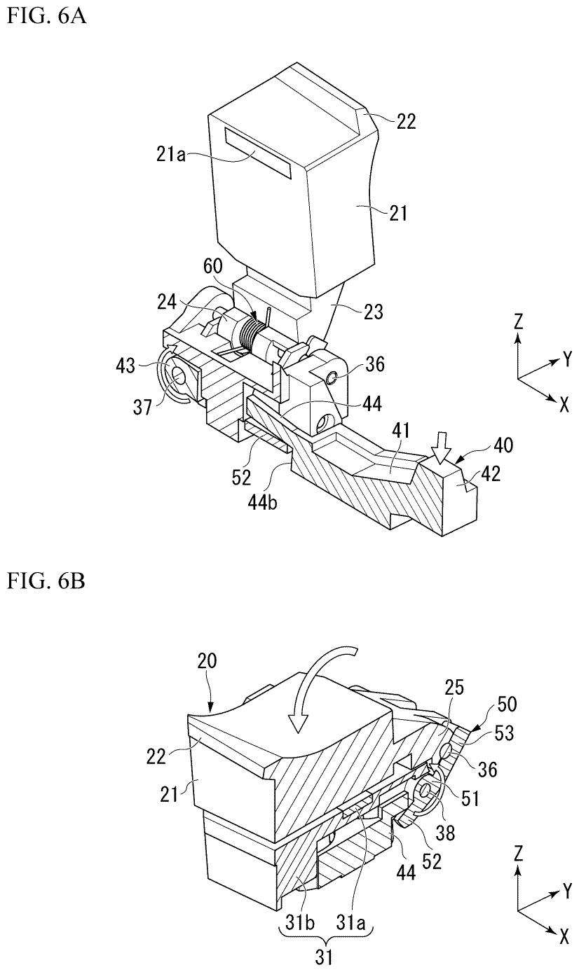

Next, the user presses down the operation part 41 with his or her finger gripping the coating portion C. At this time, the outer guide part 42 may be pressed down. When the operation part 41 or the outer guide part 42 is pressed down, a moment around the first rotation shaft 37 acts on the operation member 40, as shown in FIG. 6A. The first arm 52 is disposed inside the accommodating portion 44b of the operation member 40. For this reason, when the operation member 40 rotates downward around the first rotation shaft 37, the intermediate part 44 pushes down the first arm 52. As a result, as shown in FIG. 6B, a moment around the second rotation shaft 38 acts on the conversion part 50. As a result, the conversion part 50 rotates around the second rotation shaft 38 such that the second arm 53 rotates upward.

The second arm 53 comes into contact with the contact part 25 of the clamp member 20. For this reason, when the conversion part 50 rotates, the second arm 53 pushes up the contact part 25. As a result, a moment around the clamp rotation shaft 36 acts on the clamp member 20. This moment acts in the direction of closing the clamp member 20. Due to a leverage ratio relationship between the operation member 40 and the conversion part 50, a small rotation of the operation member 40 can be converted into a large rotation of the clamp member 20. On the other hand, a biasing force in the opening direction is applied to the clamp member 20 by the biasing member 60. Therefore, the clamp member 20 rotates in the closing direction depending on the amount by which the user presses the operation part 41 or the like. Furthermore, when the user releases his or her hand from the operation part 41 or the like, the clamp member 20 rotates in the opening direction due to the biasing force of the biasing member 60.

When the clamp member 20 rotates in the closing direction by the user pressing down the operation part 41 or the like, the distance between the magnetic member 31c and the clamp-side magnetic member 21a becomes smaller. As a result, the magnetic force generated by the magnetic member 31c and the like increases. A closing force (a force for closing the coating clamp 21) acts on the clamp member 20 on the basis of the magnetic force, the weight of the clamp member 20, and the like. When this closing force exceeds the biasing force by the biasing member 60, the interlocking between the operation part 41 and the clamp member 20 is released. In other words, even if the user stops pressing down the operation part 41 or the like, the coating clamp 21 is maintained in the closed state.

In order for the fusion splicer 1 to function as described above, the operation member 40 only needs to include at least one of the operation part 41 and the outer guide part 42, and the intermediate part 44, and the conversion part 50 only needs to include at least the first arm 52 and the second arm 53.

That is, the fusion splicer 1 may be configured such that the pedestal member 30 further includes the second rotation shaft 38 fixed to the pedestal member 30, the operation member 40 includes one of the operation part 41 and the outer guide part 42, and the intermediate part 44, the conversion part 50 includes the first arm 52 and the second arm 53, and when the one of the operation part 41 and the outer guide part 42 is pressed down, the operation member 40 rotates, the intermediate part 44 pushes down the first arm 52, the conversion part 50 rotates around the second rotation shaft 38, and the second arm 53 pushes up the clamp member 20, so that the moment around the clamp rotation shaft 36 acts on the clamp member 20 in the direction of closing the clamp member 20, and the clamp member 20 rotates in the direction toward the pedestal member 30.

By performing the above operation for both optical fibers F1 and F2, these optical fibers F1 and F2 can be clamped by the pair of coating clamps 21. The glass clamp 14 may be configured to be closed in interlocking with the coating clamp 21. Alternatively, the user may directly perform an operation to close the glass clamp 14 without interlocking with the coating clamp 21. Fusion-splicing can be performed by operating the heating unit 2a in a state in which the optical fibers F1 and F2 are fixed by the coating clamp 21 and the glass clamp 14. After performing the fusion-splicing, the user releases the fixation of the optical fibers F1 and F2 by the coating clamp 21 by pushing up the operation protrusion 22. As a result, the optical fibers F1 and F2 after the fusion splice can be removed.

The amount of rotation of the clamp member 20 relative to the amount of rotation of the operation part 41 (hereinafter simply referred to as a “leverage ratio”) and the operating force when pressing down the operation part 41 are determined by, for example, the following parameters.
A length from a position where the user presses down the operation member 40 to the first rotation shaft 37 (see FIG. 6A)
A length from the first rotation shaft 37 to a contact point between the first arm 52 and the intermediate part 44
A length from the second rotation shaft 38 to a contact point between the first arm 52 and the intermediate part 44 (see FIG. 6B)
A length from the second rotation shaft 38 to a contact point between the second arm 53 and the contact part 25
A biasing force acting on the clamp member 20 by the biasing member 60

The leverage ratio and the operating force may be changed by changing these parameters.

The above-mentioned interlocking unit U is detachable from the device main body 2. More specifically, the interlocking unit U is detachable from the movable stage 11. Therefore, it is possible to replace the interlocking unit U depending on the type of the optical fiber or the like. However, the device main body 2 does not need to include the movable stage 11. In this case, the interlocking unit U may be attached to the device main body 2 without using the movable stage 11. Moreover, in the embodiments described above, the fusion splicer 1 includes the pair of interlocking units U. However, the fusion splicer 1 may include only one of the right interlocking unit U and the left interlocking unit U. In other words, the fusion splicer 1 may include only one of the pair of operation parts 41.

As described above, the fusion splicer 1 of one or more embodiments includes: a device main body 2 including a heating unit 2a that heats a pair of optical fibers F1 and F2 arranged in a left-right direction X; a pedestal member 30 including a coating holding part 31 that holds a coating portion C of one of the pair of optical fibers F1 and F2; a clamp member 20 including a coating clamp 21 that clamps the coating portion C between the coating holding part 31 and the coating clamp 21, and rotating around a clamp rotation shaft 36 fixed to the pedestal member 30; and an operation member 40 rotating around a first rotation shaft 37 fixed to the pedestal member 30, wherein the clamp member 20 rotates in a direction toward the pedestal member 30 in interlocking with the rotation of the operation member 40 (a direction in which the coating clamp 21 is closed).

Further, a fusion-splicing method of one or more embodiments includes: a step of clamping the coating portion C of the optical fiber F1 or the optical fiber F2 with the coating clamp 21 by operating the operation part 41 with a hand gripping the optical fiber F1 or the optical fiber F2 and closing the coating clamp 21 in interlocking with the operation part 41; and a step of heating and fusion-splicing the glass portions G of the optical fiber F1 and the optical fiber F2.

According to such a fusion splicer 1 or a fusion-splicing method, the coating clamp 21 is closed in interlocking with the operation of the operation part 41, and thus the work of clamping the optical fiber F1 or F2 by the coating clamp 21 becomes easy. Therefore, it is possible to improve the efficiency of the fusion-splicing work of the optical fibers F1 and F2.

Furthermore, the coating clamp 21 is closed in interlocking with a downward rotating operation of the operation part 41. In this case, while the user holds the optical fiber F1 or F2 with his or her fingers and moves the optical fiber F1 or F2 toward the coating holding part 31, the user can easily operate the operation part 41 with those fingers. In other words, it is possible to close the coating clamp 21 with one hand while easily holding the optical fiber F1 or the optical fiber F2 with the one hand. Therefore, it is possible to further improve the efficiency of the fusion-splicing work.

Further, the fusion splicer 1 includes a pair of operation parts 41, and the pair of coating clamps 21 are closed in interlocking with the operation of the pair of operation parts 41. According to this configuration, it is possible to hold the optical fiber F1 with the coating clamp 21 (one coating clamp 21) by operating one of the operation parts 41 with one hand. At same time, it is possible to hold the optical fiber F2 with the coating clamp 21 (the other coating clamp 21) by operating the other of the operation parts 41 with the other hand. In other words, the operation of holding the optical fibers F1 and F2 with the pair of coating clamps 21 can be performed simultaneously with both hands. Therefore, it is possible to further improve the efficiency of the fusion-splicing work.

Further, the fusion splicer 1 includes the operation member 40 that includes the operation part 41 and rotates around the first rotation shaft 37, the clamp member 20 that includes one coating clamp 21 and rotates around the clamp rotation shaft 36, and the conversion part 50 that converts the operation of the operation member 40 around the first rotation shaft 37 into the operation of the clamp member 20 around the clamp rotation shaft 36. As a result, it is possible to realize a structure in which the coating clamp 21 is closed in interlocking with the operation of the operation part 41. Further, by changing the shape or the like (for example, the leverage ratio) of the conversion part 50, it is possible to easily change the operating force of the operation part 41.

Further, the interlocking unit U including the operation member 40, the clamp member 20, and the conversion part 50 is detachable from the device main body 2. According to this configuration, it is possible to replace the interlocking unit U depending on the type of the optical fibers F1 and F2 to be fusion-spliced.

Further, the fusion splicer 1 includes a pair of biasing member 60 that biases the pair of coating clamps 21 in an opening direction. According to this configuration, until a force for closing the coating clamp 21 (for example, a magnetic force or the like) exceeds the biasing force, when the operation of the operation part 41 is stopped, the coating clamp 21 is opened by the biasing force. In other words, the amount of rotation of the coating clamp 21 can be made to follow the amount of rotation of the operation part 41. Therefore, operability can be further improved.

The technical scope of the present invention is not limited to the above embodiments, and various modifications can be made without departing from the spirit of the present invention.

For example, although the fusion splicer 1 of one or more embodiments includes a pair of interlocking units U, a fusion splicer 1 including only one of the interlocking units U may be adopted.

The fusion splicer 1 may be configured such that the fusion splicer 1 includes: a device main body 2 including a heating unit 2a that heats an optical fiber F1 or an optical fiber F2; a pedestal member 30 including a coating holding part 31 that holds a coating portion C of the optical fiber F1 or the optical fiber F2; a clamp member 20 including a coating clamp 21 that clamps the coating portion C between the coating holding part 31 and the coating clamp 21, and rotating around a clamp rotation shaft 36 fixed to the pedestal member 30; and an operation member 40 rotating around a first rotation shaft 37 fixed to the pedestal member 30, wherein the clamp member 20 rotates in a direction toward the pedestal member 30 (a direction in which the coating clamp 21 is closed) in interlocking with the rotation of the operation member 40.

The structure for closing the coating clamp 21 in interlocking with the operation of the operation part 41 is not limited to that of the above embodiments, and may be modified. As a specific example, the conversion part 50 may include a plurality of members. Further, the operation of the operation member 40 or the conversion part 50 may be linear movement instead of rotational movement.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Fusion splicer
2 Device main body
2a Heating unit
13 Glass holding part
20 Clamp member
21 Coating clamp
31 Coating holding part
36 Clamp rotation shaft
37 First rotation shaft
40 Operation member
41 Operation part
50 Conversion part
60 Biasing member
C Coating portion
F1, F2 Optical fiber
G Glass portion
U Interlocking unit
X Left-right direction

1. A fusion splicer comprising:
a device main body comprising a heater that heats an optical fiber;
a pedestal comprising:
a coating holder that holds a coating of the optical fiber; and
a first rotation shaft fixed to the pedestal;
a clamp member comprising a coating clamp that clamps the coating between the coating holder and the coating clamp, wherein the clamp member rotates around a clamp rotation shaft fixed to the pedestal; and
an operation member that rotates around the first rotation shaft, wherein
the clamp member rotates in a direction toward the pedestal in interlocking with rotation of the operation member.

2. The fusion splicer according to claim 1, wherein the coating clamp closes in interlocking with a downward rotation of the operation member.

3. The fusion splicer according to claim 1, further comprising converter that converts an operation of the operation member around the first rotation shaft into an operation of the clamp member around the clamp rotation shaft.

4. The fusion splicer according to claim 3, wherein an interlocking unit including the operation member, the clamp member, and the converter is configured to be detached from the device main body.

5. The fusion splicer according to claim 3, wherein
the pedestal further comprises a second rotation shaft fixed to the pedestal,
the operation member comprises:
either one of an operation part or an outer guide part; and
an intermediate part,
the converter comprises: a first arm; and a second arm, and
in response to pressing down the either one of the operation part or the outer guide part, the operation member rotates, the intermediate part pushes down the first arm, the converter rotates around the second rotation shaft, and the second arm pushes up the clamp member such that a moment around the clamp rotation shaft acts on the clamp member in a direction of closing the clamp member and the clamp member rotates in the direction toward the pedestal.

6. The fusion splicer according to claim 1, further comprising a biasing member that biases the coating clamp in an opening direction.

7. The fusion splicer according to claim 2, further comprising a converter that converts an operation of the operation member around the first rotation shaft into an operation of the clamp member around the clamp rotation shaft.

8. The fusion splicer according to claim 7, wherein an interlocking unit including the operation member, the clamp member, and the converter is configured to be detached from the device main body.

9. The fusion splicer according to claim 4, wherein
the pedestal further comprises a second rotation shaft fixed to the pedestal,
the operation member comprises:
either one of an operation part or an outer guide part; and
an intermediate part,
the converter comprises: a first arm; and a second arm, and
in response to pressing down the either one of the operation part or the outer guide part, the operation member rotates, the intermediate part pushes down the first arm, the converter rotates around the second rotation shaft, and the second arm pushes up the clamp member such that a moment around the clamp rotation shaft acts on the clamp member in a direction of closing the clamp member and the clamp member rotates in the direction toward the pedestal.

10. The fusion splicer according to claim 7, wherein
the pedestal further comprises a second rotation shaft fixed to the pedestal,
the operation member comprises:
either one of an operation part or an outer guide part; and
an intermediate part,
the converter comprises: a first arm; and a second arm, and
in response to pressing down the either one of the operation part or the outer guide part, the operation member rotates, the intermediate part pushes down the first arm, the converter rotates around the second rotation shaft, and the second arm pushes up the clamp member such that a moment around the clamp rotation shaft acts on the clamp member in a direction of closing the clamp member and the clamp member rotates in the direction toward the pedestal.

11. The fusion splicer according to claim 8, wherein
the pedestal further comprises a second rotation shaft fixed to the pedestal,
the operation member comprises:
either one of an operation part or an outer guide part; and
an intermediate part,
the converter comprises: a first arm; and a second arm, and
in response to pressing down the either one of the operation part or the outer guide part, the operation member rotates, the intermediate part pushes down the first arm, the converter rotates around the second rotation shaft, and the second arm pushes up the clamp member such that a moment around the clamp rotation shaft acts on the clamp member in a direction of closing the clamp member and the clamp member rotates in the direction toward the pedestal.
